(19) United States
(12) Patent Application Publication
(10) Pub. No.: US 2009/0121864 A1
(43) Pub. Date: May 14, 2009

(54) DEVICES, SYSTEMS AND FUNCTIONALITY FOR FIELD PERSONNEL COMMUNICATION AND MANAGEMENT

(76) Inventor: Scott Douglas Osborne, Tampa, FL (US)

Correspondence Address: Christine McCarthy;Barnes & Thornburg, LLP, Suite 900, 750 17th Street, NW, Washington, DC, 20006, US

(21) Appl. No.: 11/939,970

(22) Filed: Nov. 14, 2007

(51) Int. Cl. H04Q 7/00

(52) U.S. Cl. 340/539.13

(57) ABSTRACT

Devices, systems and functionality are provided that enable communication with, tracking of and managing activity/movements of field personnel

The invention relates in general to communication via cellular networks. In particular, the invention relates to supporting or implementing functionality to provide increased communication and tracking capability of personnel in the field via wireless devices, as specified in the independent claims.

### BACKGROUND OF THE INVENTION

As is conventionally known in the management of personnel working in the field and/or remote from an organization's offices, field personnel members are often difficult to contact and track throughout their workday. As a result, it is often difficult to determine or verify their time at work or on particular tasks/jobs for the purposes of payroll or billing. Moreover, personnel working in the field routinely manually record their time on a particular job/task as well as the total time at particular job sites. However, this type of recordation, for the purposes of keeping track of field personnel and also for billing customers, is susceptible to problems when personnel are disorganized, not diligent or dishonest in their recordkeeping. Moreover, the management and analysis of the manually recorded time entries requires office personnel to reenter all the data into an organization's accounting system, which is, of itself, time consuming and susceptible to human error.

### SUMMARY OF THE INVENTION

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with at least one embodiment of the invention, operations and mechanisms are provided that enable communication with, tracking of and managing activity/movements of field personnel, as specified in the independent claims. This is achieved by a combination of features recited in each independent claim. Accordingly, dependent claims prescribe further detailed implementations of the present invention.

### BRIEF DESCRIPTION OF THE DRAWINGS

A more complete understanding of the present invention and the utility thereof may be acquired by referring to the following description in consideration of the accompanying drawings, in which like reference numbers indicate like features, and wherein:

FIG. 1 illustrates an environment wherein embodiments of the invention may be utilized.

FIG. 2 illustrates additional details included in a field personnel member specific portable device provided in accordance with at least one embodiment of the invention.

FIG. 3 illustrates additional details included in on potential implementation of a portable device provided in accordance with at least one embodiment of the invention.

FIG. 4 illustrates additional details of administrative application software used in accordance with at least one embodiment of the invention.

### DETAILED DESCRIPTION OF EMBODIMENTS

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in this respect.

Conventionally, various portable, field devices are available that provide communication with field personnel, e.g., cellular phones, pagers or Personal Data Assistants (PDAs). Moreover, there are a number of conventionally available services that use such devices to provide communication with, tracking of and documentation of activities performed by field personnel. However, implementing such schemes for field personnel requires significant capital outlay because each field personnel member must be issued such a device.

Moreover, when field personnel positions are subject to high turn over, e.g., when field personnel do not have specialized skills, the budget for issuing field personnel equipment tends to be lower than most field personnel members. This is particularly problematic because, often such personnel are more likely to misuse their assigned equipment, e.g., mobile phones or lose or damage the equipment. Moreover, when field personnel are travelling in teams, e.g., a senior/junior technician pair, it is often unnecessary to assign each technician a mobile communication device because the senior technician would have such equipment assigned to him.

Alternatively, conventional devices are often installed in field personnel vehicles. Although such devices enable the ability to enter job related data to an organization's office accounting and personnel management systems, such devices are very costly and track activities associated with more than one personnel member associated with a vehicle. Therefore, such schemes are not effective at communicating with, tracking and managing activities for individual personnel members when more than one personnel member is associated with a vehicle and/or the personnel members associated with devices change often.

As a third alternative, a portable time clock may be used for each field personnel member to ensure diligent recording of the beginning and ending of a field personnel job task. Such time clocks may be specific to a field location, e.g., a construction site; in such an implementation field personnel may use a personnel-specific key or code indicating their presence and work at the field location. Information generated by such a portable field location device may be provided to office accounting and personnel management systems via personnel interfacing with the portable time clock on site, e.g., using a user or equipment interface to download information, or remotely, via a wired (e.g., modem-based) or wireless communication link.

However, such portable time clock devices have problems in that portable devices would be needed at each field location, and, therefore, installed or removed there (requiring further personnel time).

As a result of recognizing these deficiencies of conventional field personnel communication, tracking and management systems, apparatuses and functionality have been designed in accordance with the invention, wherein a field personnel member-specific device is provided that enables two-way communication with field personnel.

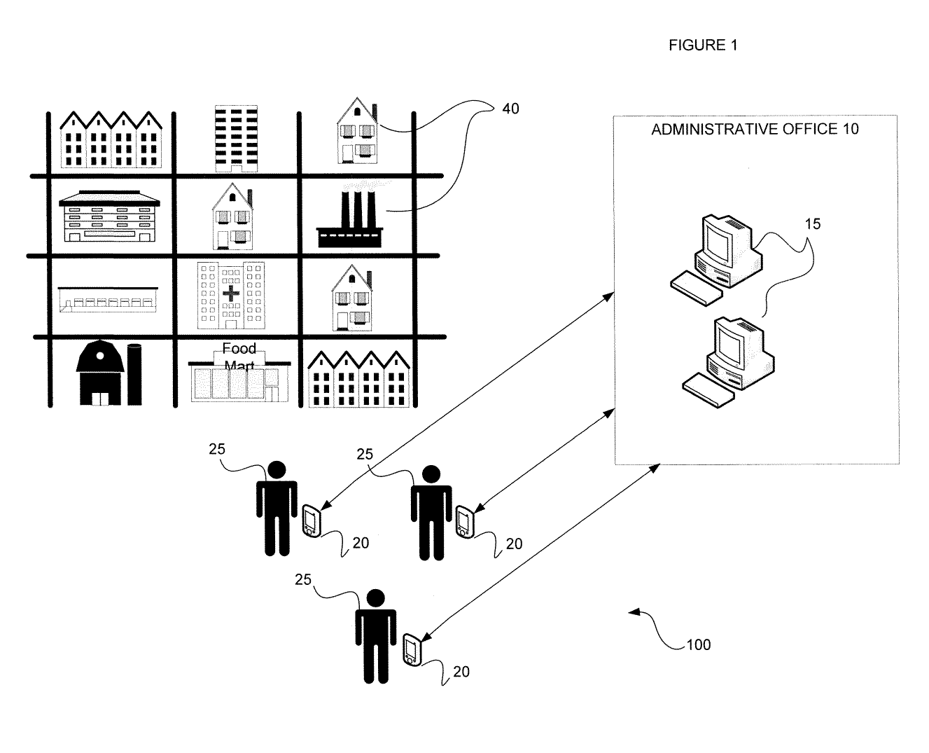

FIG. 1 illustrates an environment wherein embodiments of the invention may be utilized. As illustrated in FIG. 1, an environment 100 may include an organization administrative office 10 and a field environment 30 that may include one or more field locations 35 where field personnel 25 may perform one or more jobs/tasks as part of their job responsibilities for the organization. In accordance with at least one embodiment of the invention, software and hardware 15 located at the administrative office 10 and/or at a remote location 40 cooperate with one or more portable devices 20 assigned to or associated with one or more field personnel members 25 to provide a system, functionality and operations for improving communication with and management of field personnel members 25 through the use by the portable devices 20. These portable devices 20 may be implemented as hand-held devices capable of wireless communication and configured to enable field communication with organization administrative systems implemented in the software and hardware 15 located at the organization administrative office 10 and/or one or more remote locations 40.

As illustrated in FIG. 1, administrative software may be included in or accessible by the software and hardware 15 included in the organization's office environment. Using such administrative software, an organization's office personnel can view data transmitted from the one or more field personnel portable devices 20 in the field at any time. Accordingly, office personnel members can download data in, for example, Excel™ format or any other format, such that the data can be sorted, downloaded and exported to one or more office applications enabling payroll, billing, etc.

With real-time or near real-time availability of field personnel member's activities, an organization can efficiently perform various functions conventionally required for business profitability, e.g., billing and payroll. Additionally, up to date reports may be generated that enable administrators in an organization to determine labor efficiency percentages, identify sources of waste and inefficiency, optimize delivery of services, parts or product, etc.

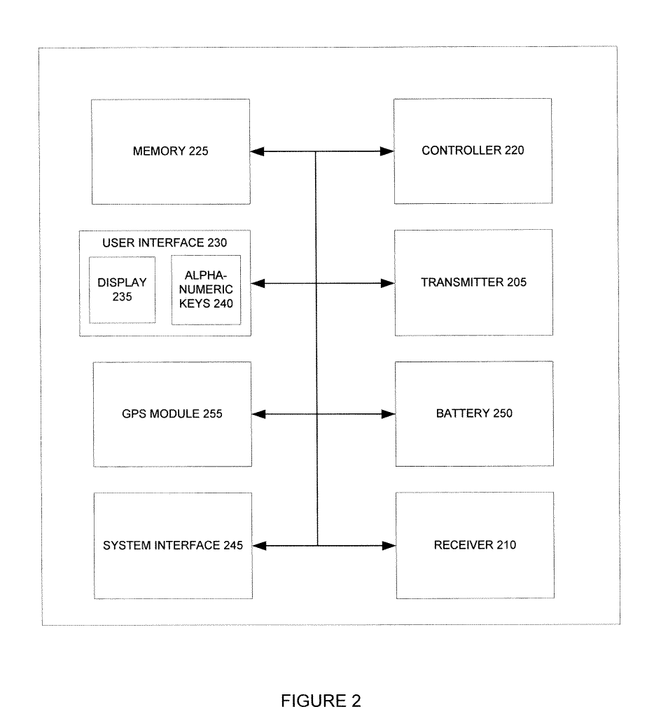

In accordance with at least one embodiment of the invention, the portable device 20 is a portable, field personnel-specific device that is approximately the size of a small conventional pager or the like. FIG. 2 illustrates additional details included in a field personnel member specific portable device 20 provided in accordance with at least one embodiment of the invention. As illustrated in FIG. 2, the portable device 20 may include an antenna 200 that is operable communication with a transmitter 205 and a receiver 210. The portable device 20 further includes a controller 220 or other processing element that provides signals to and receives signals from the transmitter 205 and receiver 210, respectively. The signals may include signalling information in accordance with an air interface standard of the applicable cellular system, and also user speech and/or user generated data.

In this regard, the portable device 20 may be capable of operating with one or more air interface standards, communication protocols, modulation types, and access types. By way of illustration, the portable device 20 may be capable of operating in accordance with any of a number of first, second and/or third-generation communication protocols or the like. For example, the portable device 20 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

Wireless connectivity may be provided to ensure secure and seamless transfer of the up to date data to/from field personnel. All data may be transmitted using 256-bit data encryption. In accordance with at least one embodiment of the invention, file-based version-management features may be used to conserve time, bandwidth and resources by transferring only updated files or data to/from the field.

The controller 220 may include circuitry required for implementing logic and/or audio/video functions of the portable device 20. For example, the controller 20 may be comprised of a digital signal processor device, a microprocessor device, and various analog to digital converters, digital to analog converters, and other support circuits. Control and signal processing functions of the portable device 20 may be allocated between these components according to their respective capabilities. The controller 220 thus may also include the functionality to convolutionally encode and interleave message and data prior to modulation and transmission. The controller 220 may additionally include an internal data modem. Further, the controller 220 may include functionality to operate one or more software programs, which may be stored in memory 225. For example, the controller 20 may be capable of operating a connectivity program, such as a conventional Web browser. The connectivity program may then allow the portable device 20 to transmit and receive Web-based content, such as location-based content, according to a Wireless Application Protocol (WAP), for example.

The portable device 20 may also comprise a user interface 230 including an output device component such as a conventional Liquid Crystal Display (LCD) 235 and/or an input device component such as a plurality of alpha numeric keys 240. Moreover, the user interface 230 may be configured to enable the portable device 20 to receive data from a field personnel member, may include any of a number of devices allowing the portable device 20 to receive data, such as a keypad, a touch display (not shown) or other input device. In embodiments including the keypad, the keypad may include the conventional numeric (0-9) and related keys (#, *), and other keys used for operating the portable device 20. Alternatively, the keypad may include a conventional QWERTY keypad.

Alternatively, depending on cost constraints, the portable device 20 may also include various other user interface components depending on functionality included in the portable device; thus, such components may include an earphone or speaker, a ringer, a microphone, a camera, all of which maybe coupled to the controller 220.

In accordance with at least one embodiment of the invention various software may stored in the memory 225 configured to enable the portable device 20 to download data associated with jobs/tasks to be performed by the field personnel member. It should be appreciated that such downloading may be performed when the field personnel is at the organization's administrative office 10 via a systems interface 245. Such an interface 245 may interact with the administrative office software and hardware via a docking station or interface (not specifically illustrated).

Thus, in accordance with at least one embodiment of the invention, wireless transmission of data entered by field personnel members may be an option that is available with the payment of a subscription fee, whereas data may also or alternatively be downloaded to an organization's administrative software manually by docking the portable device to hardware located in an organizations administrative environment.

In addition the portable device 20 may include a portable systems interface 215 that includes software that communicates with the administrative office software and hardware via the antenna 200, transmitter 205 and receiver 210.

In accordance with at least one embodiment of the invention, the device 20 may be programmed with software (e.g., manually, or via Over The Air (OTA) programming) to enable input of information associated with predetermined tasks or jobs specific to the field personnel member. As a result, the field personnel member may easily access such a list of tasks or jobs to identify what duties are to be performed for a specified period of time, e.g., the work day or work week. Furthermore, comments and address fields may provided in connection with such tasks or jobs such that the field personnel is able to determine where and what tasks or jobs are to be performed as well as particulars associated with the specified tasks or jobs, e.g., promised arrival time, specified materials or job requirements, etc.

Thus, when field personnel arrive at a field location, e.g., a construction site or facility, the personnel member may scroll down to select a particular job and “clock in” for a specified task (i.e., indicating the start time of the job/task. In accordance with at least one implementation of the invention, the field personnel may not clock into another task until he has clocked out of an open task. This functionality assists in deterring field personnel from double billing for their time on a jobsite to more than one account or task.

While the field personnel member is clocked into a particular job/task, the personnel member can input comments into a custom field in the job entry via the interface 230. Thus, field personnel can add a simple comment like “installed cable box” or enter an organization's billing code to be easily exported to an invoice.

In accordance with at least one embodiment of the invention, when the field personnel member has completed a job/task, the user may select a “clock out” operation. Subsequently, the field personnel member may select another task/job from a list provided by the personnel member's organization or enter his own. As explained briefly above, the task/job may be specific to the field personnel member, e.g., the member's organization has provided a list of tasks/jobs for the member to complete for a particular period or at a particular field location. Alternatively, a listing of tasks/jobs may be generalized to the skill set of the field personnel member, e.g., a member who is a carpenter may have a different set of tasks/jobs than a member who is a plumber. Further, a listing of tasks/jobs may be generalized for all members of a particular organization or organization department. Further, the user interface 205 may enable the field personnel member to enter custom or personalized job/task data, e.g., if a new task/job occurs during a field location visit or was not pre-loaded as an option of task/job lists in the device 20.

Additionally, the user interface 205 may be configured to enable a field personnel member to manually enter a job/task name or number, address, or other data in one or more custom fields associated with each job/task (e.g., billing information, part numbers, comments, etc).

The portable device 20 further includes a battery 250, such as a vibrating battery pack, for powering various circuits that are required to operate the portable device 20, as well as optionally providing mechanical vibration as a detectable output. It should be appreciated that such a battery 250 may be rechargeable via either DC or AC powered connectors.

The portable device may also include GPS module 255 configured to A GPS receiver calculates its position by measuring the distance between itself and three or more GPS satellites. Measuring the time delay between transmission and reception of each GPS microwave signal gives the distance to each satellite, since the signal travels at a known speed near the speed of light. These signals also carry information about the satellites' location and general system health (known as almanac and ephemeris data). By determining the position of, and distance to, at least three satellites, the receiver can compute its position using trilateration. Receivers typically do not have perfectly accurate clocks and therefore track one or more additional satellites, using their atomic clocks to correct the receiver's own clock error.

The GPS module 255 of the portable device 20 may be configured to transmit data on a periodic basis, e.g., every 5 seconds via, for example, Global System of Mobile Communication (GSM) technology. The data transmitted by the portable device 20 may be analyzed and enable the presentation of the portable device 20 (and hence, field personnel member) at a GPS location on a map, e.g., a map provided by Google Maps, at the organization's office location via the administrative software.

In accordance with at least one embodiment of the invention, transmission of the GPS module 255 may be used to locate a field personnel member at any time. In accordance with at least one embodiment of the invention GPS tracking and time stamping of field personnel member location may aid in ensuring that customer service objectives are met. For example, when customers are not home for a scheduled maintenance job, GPS tracking provides the ability to reliably identify when field personnel attempted to perform scheduled service or delivery.

In accordance with at least one embodiment of the invention, a plurality of portable devices are provided that are configured to communicate with administrative software and provide functionality that aids in the communication with, tracking of field personnel as well as documentation of tasks/jobs performed by such field personnel. Moreover, in accordance with at least one implementation of the invention, a system including these components may be provided in an inexpensive solution where the portable devices are inexpensive enough for all or a significant portion of field personnel to be assigned a device.

In such an implementation, a subscription may be activated for a senior member of a field personnel team who is responsible for job/task documentation; however, GPS functionality may be operational for all members of the team to ensure that field personnel are not shirking their responsibilities.

A subscription fee for activating a subscription for enabling wireless transmission of field personnel member's input data may be scalable based on the number of subscriptions activated or portable devices used in an organization.

Further, it should also be appreciated that, alternatively, GPS mapping, e.g., the ability to identify a portable device's location on a geographic map, may be provided only as an upgrade to a base subscription service.

In accordance with at least one embodiment of the invention, transmission of the GPS module 255 may be used to validate the field personnel member's location when the member clocks into and/or out of a particular job/task to ensure that the member is actually located at the appropriate field location for the job/task.

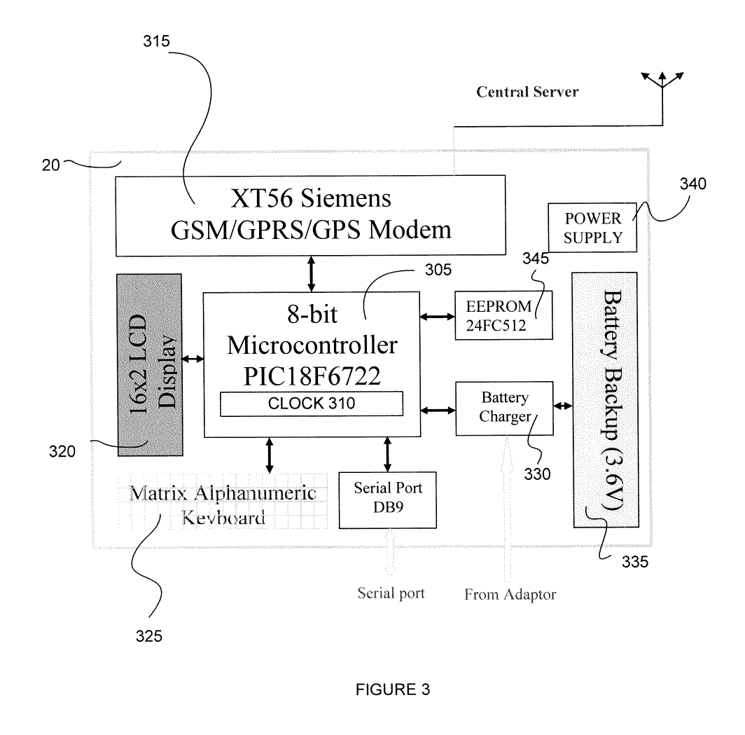

In accordance with at least one embodiment of the invention, an illustrative example being provided in FIG. 3, the portable device 20 may be implemented using, among other components, an 8 bit micro-controller 305, a Real Time Clock 310, a GSM/GPRS/GPS Modem 315, an LCD 320, alphanumeric keypad 325, battery backup 330, battery charger 335 and a power supply 340.

The 8 bit micro-controller 305 may be implemented using, for example, a PIC18F6722 micro-controller having 128K flash, which may be configured to control all device functionality like handling the display, GPS+GPRS module, user inputs and serial interface with any administrative application. The portable device may collect IN and OUT time data along with the a current location (latitude, longitude) of the device 20 with a XT56 Siemens GSM/GPRS/GPS Modem 315 (implementing various functionality components illustrated in FIG. 2 to receive and transmit using, for example, a GPRS link at a web server (e.g., central server). The portable device may also log the current location in the portable device itself, e.g., in EEPROM 345. The RTC 310 may be configured to keep record of the check IN and OUT time in the EEPROM 345.

The GSM/GPRS/GSM modem 314 may be used to track the location data and transfer the same to the web server. The web server may be implemented at an organization's administrative offices or at a remote location and be connected to the Internet using, for example, a direct static IP address. GPRS may be used to connect to the remote web server having static IP using TCP/IP wireless link so that the organization can track field personnel members.

The LCD 320 may be used to display relevant text messages as well as programmed job/task titles to the field personnel member. The alphanumeric keypad 325 may be configured to enable field personnel members to make inputs data used by or accessible by administrative applications used at the administrative offices, e.g., to edit job/task titles, input comments, numbers etc. The battery backup 330 may include, for example, a 3.6V lithium-ion battery to power the portable device, which will require charging occasionally to keep the device operational. Accordingly, the battery charger 335 may be included in the device 20 and may be implemented to correspond to the size of the battery used in the battery backup 330. The power supply 340 may be implemented using, for example, a 3.3VDC battery.

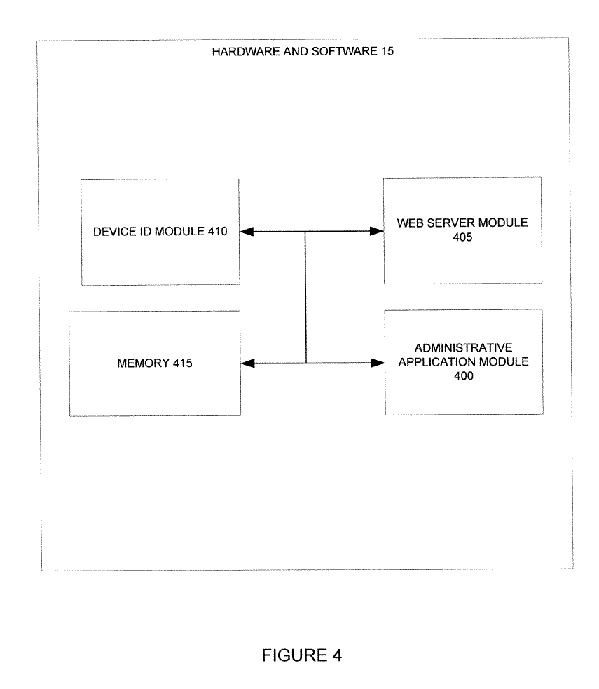

In accordance with at least one embodiment of the invention, the software included in 15 illustrated in FIG. 1 may include but is not limited to various administrative modules configured to enable communication with the portable devices 20. For example, as illustrated in FIG. 4, the software may include an administrative application module 400, a web server module 405 and a device ID module 410. The administrative application module 400 may be configured to control uploading of data from the portable devices and storing it to one or more databases included in memory 415 located either at the administrative offices or remotely. More specifically, the administrative application module 400 is configured to provide users with various options by which user can assign an organization device ID, add or edit the task, store data in databases of memory 415 and view reports. Various options are available to users via the administrative application module including login (which may be configured to query for user name and password) add device/task (configured to enable assignment of an organization device ID), read task (triggering display of one or more jobs/tasks to be performed by the field personnel member with associated job/task data), log data (triggering uploading of data from the portable device to the organization administrative software and memory), report (enabling generation of various types of reports that may be selected from a data field that includes, e.g., device ID, job number, job name, time in, time in location, time out, time out location, date, etc.) change password (configured to enable changing of an existing password to a new password).

The web server module 405 may be configured to determine and/or verify the location of the portable devices through, for example, the Internet on map (e.g., using Google.earth™). The device ID module 410 may be configured to enable changing of a device ID if a portable device is reassigned to a different field personnel member.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

As a result, it will be apparent for those skilled in the art that the illustrative embodiments described are only examples and that various modifications can be made within the scope of the invention as defined in the appended claims.

1. A system for communicating with and tracking field personnel, the system comprising:
a central server coupled to or in communication with administrative software utilized by an organization employing field personnel; and
a plurality of portable field personnel specific devices each configured to receive data from the central server, accept data entry by field personnel associated with the field personnel specific device and transmit location data for determining the location of the field personnel specific device,
wherein location data is transmitted to the central server in association with data indicating when a job is begun or completed by the field personnel.

2. The system of claim 1, wherein the administrative software includes payroll software.

3. The system of claim 1, wherein the administrative software includes billing software.

4. The system of claim 1, wherein the location data enables the administrative software to identify the location of the field personnel on a software representation of a map.

5. The system of claim 1, wherein at least one portable field personnel specific device is configured to accept job data entry from field personnel regarding a job assigned to the field personnel.

6. The system of claim 5, wherein the job data includes materials used on the job and an amount of time spent by the field personnel on the job.

7. The system of claim 1, wherein at least one of the portable field personnel specific devices is configured to communicate with the central server via wireless communication.

8. The system of claim 1 wherein data transmitted from at least one of the field personnel specific portable devices is in a database format such that the data can be sorted, downloaded and exported to the administrative software.

9. The system of claim 8, wherein the administrative software is configured to generate reports based on the data transmitted from the at least one field personnel specific portable device.

10. The system of claim 9, wherein the report provides information regarding efficiency.

11. The system of claim 1, wherein each of the plurality of field personnel specific portable devices a transmitter, a receiver and a controller for controlling transmission of data to and from the field personnel specific portable device.

12. A field personnel specific device comprising:
means for receiving data from a central server;
means for accepting data entry by field personnel associated with the field personnel specific device; and
means for transmitting location data for determining the location of the field personnel specific device in association with data indicating when a job is begun or completed by the field personnel.

13. The device of claim 12, wherein the location data enables the administrative software to identify the location of the field personnel on a software representation of a map.

14. The device of claim 12, wherein the means for accepting data entry by field personnel is configured to accept job data entry from field personnel regarding a job assigned to the field personnel.

15. The device of claim 14, wherein the job data includes materials used on the job and an amount of time spent by the field personnel on the job.

16. The device of claim 12, wherein the means for receiving and means for transmitting are configured to do so via wireless communication.

17. The device of claim 1, wherein data transmitted from device is in a database format such that the data can be sorted, downloaded and exported to administrative software.

18. The device of claim 12, wherein the means for receiving includes a receiver, the means for transmitting includes a transmitter and the means for accepting data entry includes a user interface.

19. The device of claim 18, wherein the receiver and transmitter are included in a modem.

20. A field personnel specific device comprising:
a receiver and transmitter included in a modem configured to receive and transmit data to and from a central server;
a user interface configured to output to and receive input data entry from field personnel associated with the field personnel specific device; and
a memory configured to store data received by the device either via the modem or the user interface,
wherein the device is configured to transmit location data for determining the location of the field personnel specific device in association with data indicating when a job is begun or completed by the field personnel.

21. The device of claim 20, wherein the location data is provided via Global Positioning System (GPS) technology.

22. The device of claim 20, wherein the location data enables the administrative software to identify the location of the field personnel on a software representation of a map.

23. The device of claim 20, wherein data entered by field personnel includes job data regarding a job assigned to the field personnel.

24. The device of claim 23, wherein the job data includes materials used on the job and an amount of time spent by the field personnel on the job.

25. The device of claim 23, wherein the modem is a wireless modem.
